(19) United States
(12) Patent Application Publication
(10) Pub. No.: US 2009/0150963 A1
(43) Pub. Date: Jun. 11, 2009

(54) BROADCAST-RECEIVING APPARATUS AND SYNCHRONIZATION METHOD THEREOF

(75) Inventor: Jae-han Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/124,189

(22) Filed: May 21, 2008

(30) Foreign Application Priority Data
Dec. 11, 2007 (KR) 10-2007-0128252

(51) Int. Cl. H04N 7/173

(52) U.S. Cl. 725/133

(57) ABSTRACT

A broadcast-receiving apparatus and a synchronization method thereof are disclosed, the broadcast-receiving apparatus including a control unit which controls to record a broadcast program on an external apparatus according to broadcast information received from the external apparatus via a short range wireless communication method. Accordingly, recording of a broadcast program being played back on the external apparatus can be continued on the broadcast receiving apparatus.

### CROSS-REFERENCE TO RELATED APPLICATIONS

This application claims priority from Korean Patent Application No. 10-2007-0128252, filed on Dec. 11, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to a broadcast-receiving apparatus and synchronization method thereof, and more particularly, to synchronization between the broadcast-receiving apparatus and a multimedia apparatus so that a user can continuously view the broadcasting, and a synchronization method thereof.

2. Description of the Related Art

Broadcasting stations provide users with various services using digital broadcasting. Digital broadcasting includes the process of digitizing a broadcast signal such as audio, video, or data, processing the signal, and transmitting or receiving the signal using a transmission system according to a digital method. A user manipulates buttons provided on a broadcast-receiving apparatus or a remote controller to replay or pause the digital broadcasting.

With the development of digital technology and products, multimedia apparatuses other than the broadcast-receiving apparatuses are also capable of playing back and pausing the digital broadcasting. Digital multimedia broadcasting (DMB) has been introduced to support mobile multimedia broadcast services combining broadcasting and communication. DMB terminals supporting multimedia broadcast services have become widely used, and thus user demand for DMB terminals has increased.

If a user returns home while viewing broadcast through a DMB terminal outside the home, the user may desire to view the broadcast through a broadcast-receiving apparatus. In this situation, it is inconvenient for the user to view the broadcast through the broadcast-receiving apparatus instead of the DMB terminal due to the synchronization discrepancy caused by differences in the decoding time of the broadcast-receiving apparatus and the DMB terminal.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a broadcast-receiving apparatus which carries out time synchronization between the broadcast-receiving apparatus and a multimedia apparatus, so that a user can continuously view broadcasting through the broadcast-receiving apparatus while also viewing broadcasting through the multimedia apparatus, and a synchronization method thereof

According to an exemplary aspect of the present invention, there is provided a broadcast-receiving apparatus, including an interface which receives broadcast information from an external apparatus; and a control unit which controls to record a broadcast program being played back on the external apparatus according to the received broadcast information.

The control unit may control to simultaneously record and play back the broadcast program.

The external apparatus may be a digital multimedia broadcasting (DMB) terminal, and the broadcast information may include at least one of a channel number and time information corresponding to the broadcast program being played back on the DMB terminal.

The time information may represent the time at which a user inputs a command to convert between the broadcast receiving apparatus and the DMB terminal, and the control unit may control to record the broadcast program between the time at which the conversion command is input and the time at which the broadcast program is terminated.

If a user inputs a command to play back the recorded broadcast program, the control unit may control to play back the broadcast program from the time at which the conversion command is input.

The control unit may control to replay the recorded broadcast program from the time which a user predetermines.

The interface may receive the broadcast information from the external apparatus via a short range wireless communication method.

The apparatus may further include a broadcast reception unit which receives the broadcast program from a broadcasting station or satellite; a processing unit which processes the broadcast program received from the broadcast reception unit by performing video decoding, video scaling, and audio decoding; an audio output unit which outputs an audio signal decoded by the processing unit; and a graphical user interface (GUI) generation unit which combines a GUI with a video decoded by the processing unit, and outputs the video.

According to an exemplary aspect of the present invention, there is provided a synchronization method of a broadcast receiving apparatus, including receiving broadcast information from an external apparatus; and recording a broadcast program being played back on the external apparatus according to the received broadcast information.

The recording may comprise simultaneously recording and replaying the broadcast program.

The external apparatus may be a digital multimedia broadcasting (DMB) terminal, and the broadcast information comprises at least one of a channel number and time information corresponding to the broadcast program being played back on the DMB terminal.

The time information may represent the time at which a user inputs a command to convert the broadcasting between the broadcast receiving apparatus and the DMB terminal, and the recording may record the broadcast program between the time at which the conversion command is input and the time at which the broadcast program is terminated.

If a user inputs a command to play back the recorded broadcast program, the recording may include playing back the broadcast program from the time at which the conversion command is input.

The recording may include playing back the recorded broadcast program from the time which a user predetermines.

According to an exemplary aspect of the present invention, there is provided a multimedia apparatus, including a manipulation unit which receives a conversion command from a user; and a control unit which generates broadcast information of a currently played back broadcast program, and transmits the generated broadcast information to an external apparatus, if the conversion command is input through the manipulation unit.

The broadcast information may include at least one of a channel number and time information corresponding to the currently played back broadcast program.

According to an exemplary aspect of the present invention, there is provided a broadcast receiving apparatus, including an interface which receives broadcast information from an external apparatus; and a control unit which controls to play back a broadcast program on the external apparatus according to the received broadcast information.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a broadcast-receiving apparatus according to an exemplary embodiment of the present invention;

FIG. 2 is a block diagram illustrating a multimedia apparatus according to an exemplary embodiment of the present invention;

FIG. 3 is a flowchart illustrating a time shift replay method of a broadcast-receiving apparatus according to an exemplary embodiment of the present invention; and

FIG. 4 is a flowchart illustrating the operation of a broadcast-receiving apparatus according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

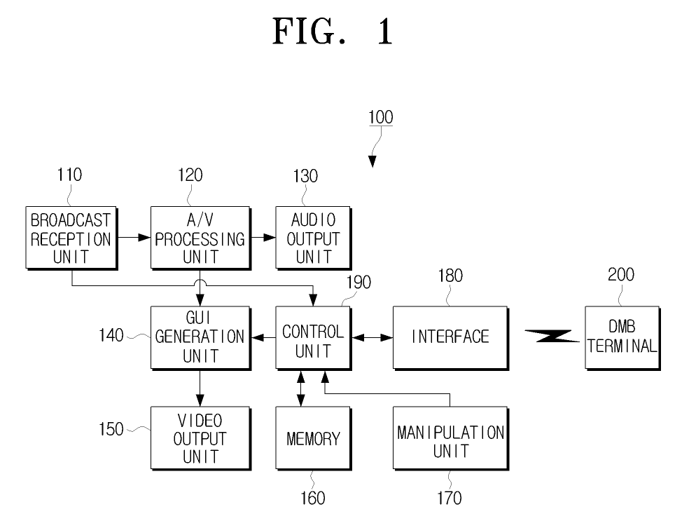

FIG. 1 is a block diagram illustrating a broadcast-receiving apparatus according to an exemplary embodiment of the present invention.

Referring to FIG. 1, a broadcast-receiving apparatus 100 may comprise a broadcast reception unit 110, an audio and video (ANV) processing unit 120, an audio output unit 130, a graphical user interface (GUI) generation unit 140, a video output unit 150, a memory 160, a manipulation unit 170, and a interface 180, and a control unit 190.

The broadcast reception unit 110 receives broadcast or content from a broadcasting station or satellite by wire or wirelessly, and demodulates the received broadcast or content.

The broadcast reception unit 110 receives from a broadcasting station or satellite the broadcast program corresponding to a channel included in broadcast information received from the control unit 190, and demodulates a signal of the received broadcast program.

The ANV processing unit 120 processes a broadcast signal output from the broadcast reception unit 110 by performing video decoding, video scaling, and audio decoding. The ANV processing unit 120 transmits a video signal and audio signal to the GUI generation unit 140 and audio output unit 130, respectively.

The audio output unit 130 outputs an audio signal output from the AN processing unit 120 through a speaker or an external apparatus connected to an external output terminal.

The GUI generation unit 140 generates a GUI to be displayed on a display, that is, to be displayed on the video output unit 150, and displays the generated GUI together with a video output from the AN processing unit 120.

The video output unit 150 displays a video together with the GUI output from the GUI generation unit 140 on the display, or outputs the video to an external apparatus connected to an external output terminal (not shown).

The control unit 190 controls the memory 160 to store various programs related to the overall operation of the broadcast-receiving apparatus 100, content received from the broadcast-receiving apparatus 100, and a broadcast program received based on the broadcast information. The broadcast information comprises a channel number and time information. The channel number represents a number of a channel being replayed on a DMB terminal 200 of a multimedia apparatus, and the time information represents the time at which a user inputs a conversion command for recording the broadcast program being replayed on the DMB terminal 200.

The manipulation unit 170 is implemented using a key button or touch panel, and receives commands from a user for operating the broadcast-receiving apparatus 100. The manipulation unit 170 receives from a user a command to replay the broadcast program recorded in the memory 160.

The interface 180 receives broadcast information from the DMB terminal 200, and outputs the received broadcast information to the control unit 190 via a short range wireless communication method. The short range wireless communication method may be a ZigBee, Bluetooth, or ad-hoc communication method.

The control unit 190 controls the broadcast reception unit 110 and the memory 160 to receive the broadcast program being replayed on the DMB terminal 200 based on the broadcast information received through the interface 180 from the DMB terminal 200, and to record the received broadcast program.

More specifically, if broadcast information is received through the interface 180 from the DMB terminal 200, the control unit 190 controls the broadcast reception unit 110 to receive the broadcast program corresponding to the time information and channel number included in the received broadcast information. The time information represents the time at which a conversion command is input to the DMB terminal 200.

The control unit 190 controls the broadcast reception unit 110 to receive a broadcast program corresponding to a selected channel number between the time at which the conversion command is input and the time at which the broadcast program is terminated. The control unit 190 records the received broadcast program in the memory 160.

While the control unit 190 controls the broadcast reception unit 110 to receive a part of the broadcast program corresponding to the channel number and time information, the present invention should not be considered to be limited to such a configuration. The control unit may also control the broadcast reception unit 110 to receive the entire broadcast program according to the channel number and time at which the conversion command is input. The control unit 190 records the broadcast program between the initial time and the termination time, or the broadcast program between the time at which a conversion command is input and the time at which the broadcast program is terminated, in the memory 160.

If a user inputs a play back command using the manipulation unit 170, the control unit 190 plays back the broadcast program recorded in the memory 160.

That is, if the play back command is input, the control unit 190 controls the GUI generation unit 140 to display the broadcast program recorded in the memory 160 on the video output unit 150 from the time at which the conversion command is input according to the broadcast information received through the interface 180.

Although the control unit 190 receives a command for playing back a recorded broadcast program through the manipulation unit 170, this should not be considered limiting. Alternatively, the control unit 190 may also receive a command for playing back a recorded broadcast program through a remote controller (not shown) to play back the recorded broadcast program.

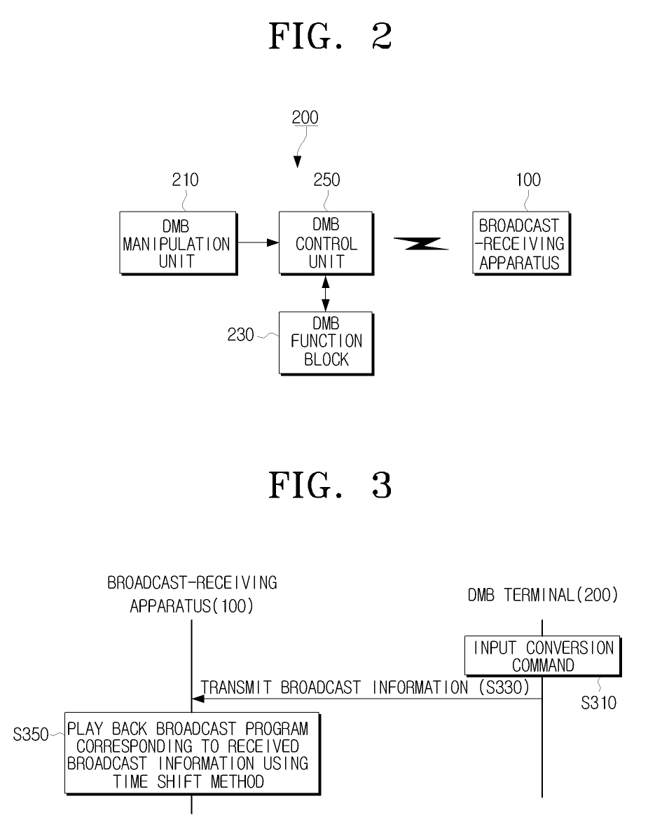

FIG. 2 is a block diagram illustrating a multimedia apparatus according to an exemplary embodiment of the present invention. In the exemplary embodiment of the present invention, a DMB terminal is provided as a multimedia apparatus for a convenient description.

Referring to FIG. 2, the DMB terminal 200 may comprise a DMB manipulation unit 210, a DMB function block 230, and a DMB control unit 250.

The DMB manipulation unit 210 is implemented using key buttons or a touch pad whereby commands for operating the DMB terminal 200 are received from a user. The DMB manipulation unit 210 receives a conversion command for recording the broadcast program being displayed on the DMB terminal 200 from a user.

The DMB function block 230 carries out basic functions such as receiving a broadcast program from a broadcasting station or satellite, demodulating the received broadcast program, and playing back the broadcast program.

If a conversion command is input through the DMB manipulation unit 210, the DMB control unit 250 generates broadcast information of the broadcast program being currently displayed, and transmits the generated broadcast information to the broadcast-receiving apparatus 100. The broadcast information comprises at least one of the channel number of the currently displayed broadcast program and the time at which the conversion command is input. The DMB terminal 200 transmits the broadcast information to the broadcast-receiving apparatus 100 via a short range wireless communication method. The short range wireless communication method may be ZigBee, Bluetooth, or an ad-hoc communication method.

FIG. 3 is a flowchart illustrating a time shift replay method of a broadcast-receiving apparatus according to an exemplary embodiment of the present invention.

Referring to FIG. 3, if a conversion command is input through the DMB manipulation unit 210 (S310), the DMB control unit 250 generates broadcast information of the broadcast program currently being displayed. The broadcast information comprises at least one of the channel number of the currently displayed broadcast program and the time at which the conversion command is input.

The DMB control unit 250 transmits the generated broadcast information to the broadcast-receiving apparatus 100 via a short range wireless communication method (S330). The short range wireless communication method may be a ZigBee, Bluetooth, or ad-hoc communication method.

The control unit 190 of the broadcast-receiving apparatus 100 plays back the broadcast program corresponding to the received broadcast information using a time shift method (S350). The time shift reproduction represents a function in which a broadcast program is simultaneously played back while the received broadcast program is being recorded. That is, the control unit 190 records and replays the broadcast program being replayed on the DMB terminal 200 from the time at which a conversion command is input.

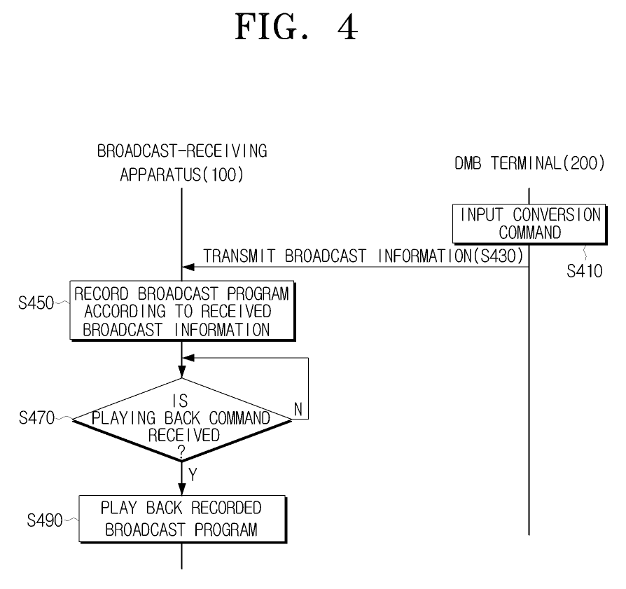

FIG. 4 is a flowchart illustrating the operation of a broadcast-receiving apparatus according to an exemplary embodiment of the present invention.

Referring to FIG. 4, if a conversion command is input through the DMB manipulation unit 210 (S410), the DMB control unit 250 generates broadcast information of the currently displayed broadcast program. The broadcast information comprises at least one of the channel number of the currently displayed broadcast program and the time at which the conversion command is input.

The DMB control unit 250 transmits the generated broadcast information to the broadcast-receiving apparatus 100 (S430). The DMB control unit 250 transmits the broadcast information to the broadcast-receiving apparatus 100 via a short range wireless communication method. The short range wireless communication method may be a ZigBee, Bluetooth, or ad-hoc communication method.

The control unit 190 of the broadcast-receiving apparatus 100 records the corresponding broadcast program according to the received broadcast information (S450).

More specifically, the control unit 190 controls the broadcast reception unit 110, receives the broadcast program corresponding to a channel number included in the received broadcast information from a broadcasting station or satellite, and records the received broadcast program in the memory 160. The control unit 190 receives and records a broadcast program from among the broadcast program according to the channel number and the conversion command input time included in the broadcast information between the time at which a conversion command is input and the time at which the broadcast program is terminated.

If a command for playing back a recorded broadcast program is received (S470:Y), the control unit 190 plays back the recorded broadcast program stored in the memory 160 (S490).

That is, if a user inputs the play back command using the manipulation unit 170, the control unit 190 controls the GUI generation unit 140 to plays back the broadcast program recorded in operation S450 on the video output unit 150. The video output unit 150 displays the broadcast program between the time at which the conversion command is input and the time at which the broadcast program is terminated.

The video output unit 150 displays the broadcast program from the time at which the conversion command is input.

According to the broadcast-receiving apparatus and synchronization method of the exemplary embodiments, the control unit 190 records the broadcast program received according to the broadcast information in the memory 160 of the broadcast-receiving apparatus 100, but this should not be considered limiting. The control unit 190 may also record a broadcast program in an external recording medium such as an external hard disc drive (HDD) connected to the broadcast-receiving apparatus 100.

The broadcast-receiving apparatus according to the exemplary embodiment of the present invention is disclosed, but this is merely an exemplary embodiment of the present invention. The present invention may also be applied to other broadcast-receiving apparatuses such as a personal video recorder (PVR), home theater, or television (TV), and video apparatuses such as a digital versatile disc (DVD) player, personal computer (PC), digital camera, or digital camcorder.

The DMB terminal is used as an example of the multimedia apparatus in the exemplary embodiment of the present invention, but the present invention is not limited thereto. The present invention may also be applied to multimedia apparatuses other than the DMB terminal, including various portable apparatuses having a broadcast reception function, such as a mobile phone, navigation device, or a personal multimedia player (PMP).

According to the broadcast-receiving apparatus and the synchronization method of the exemplary embodiments of the present invention, if a conversion command is input through the DMB terminal, the broadcast information corresponding to the broadcast program being played back on the DMB terminal is transmitted to the broadcast-receiving apparatus. Alternatively, if the DMB terminal is positioned within a predetermined range of the area wherein the broadcast-receiving apparatus is located, the DMB terminal may transmit the broadcast information to the broadcast-receiving apparatus.

As described above, according to the exemplary embodiments of the present invention, time synchronization is carried out between the broadcast-receiving apparatus and multimedia apparatus, so the broadcast-receiving apparatus continuously plays back the broadcast program on the multimedia apparatus without losing part of the broadcast program.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A broadcast-receiving apparatus comprising:
an interface which receives broadcast information from an external apparatus; and
a control unit which controls to record a broadcast program being played back on the external apparatus according to the received broadcast information.

2. The broadcast-receiving apparatus of claim 1, wherein the control unit controls to simultaneously record and play back the broadcast program.

3. The broadcast-receiving apparatus of claim 1, wherein the external apparatus is a digital multimedia broadcasting (DMB) terminal, and the broadcast information comprises at least one of a channel number and time information corresponding to the broadcast program being played back on the DMB terminal.

4. The broadcast-receiving apparatus of claim 3, wherein the time information indicates a time at which a command to convert between the broadcast receiving apparatus and the DMB terminal is input, and the control unit controls to record the broadcast program between the time at which the command to convert between the broadcast receiving apparatus and the DMB terminal is input and a time at which the broadcast program is terminated.

5. The broadcast-receiving apparatus of claim 4, wherein if a command to play back the recorded broadcast program is input, the control unit controls to play back the broadcast program from the time at which the conversion command is input.

6. The broadcast-receiving apparatus of claim 1, wherein the control unit controls to replay the recorded broadcast program from the time which a user predetermines.

7. The broadcast-receiving apparatus of claim 1, wherein the interface receives the broadcast information from the external apparatus via a short range wireless communication method.

8. The broadcast-receiving apparatus of claim 1, further comprising:
a broadcast reception unit which receives the broadcast program from a broadcasting station or satellite;
a processing unit which processes the broadcast program received from the broadcast reception unit;
an audio output unit which outputs an audio signal decoded by the processing unit; and
a graphical user interface (GUI) generation unit which combines a GUI with a video decoded by the processing unit, and outputs the video.

9. A synchronization method of a broadcast receiving apparatus, the synchronization comprising:
receiving broadcast information from an external apparatus; and
recording a broadcast program being played back on the external apparatus according to the received broadcast information.

10. The synchronization method of claim 9, wherein the recording comprises:
simultaneously recording and playing back the broadcast program.

11. The synchronization method of claim 9, wherein the external apparatus is a digital multimedia broadcasting (DMB) terminal, and the broadcast information comprises at least one of a channel number and time information corresponding to the broadcast program being played back on the DMB terminal.

12. The synchronization method of claim 10, wherein the time information represents a time at which a command to convert the broadcasting between the broadcast receiving apparatus and the DMB terminal is input, and the recording the broadcast program comprises the broadcast program between the time at which the command to convert the broadcasting between the broadcast receiving apparatus and the DMB terminal is input and a time at which the broadcast program is terminated.

13. The synchronization method of claim 11, wherein if a command to play back the recorded broadcast program is input, the recording comprises playing back the broadcast program from a time at which the conversion command is input.

14. The synchronization method of claim 9, wherein the recording comprises:
playing back the recorded broadcast program from a predetermined time.

15. A multimedia apparatus comprising:
a manipulation unit which receives a conversion command; and
a control unit which generates broadcast information of a currently played back broadcast program, and transmits the generated broadcast information to an external apparatus, in response to the conversion command received through the manipulation unit.

16. The multimedia apparatus of claim 15, wherein the broadcast information comprises at least one of a channel number and time information corresponding to the currently played back broadcast program.

17. A broadcast receiving apparatus comprising:
an interface which receives broadcast information from an external apparatus; and
a control unit which controls to play back a broadcast program on the external apparatus according to the received broadcast information.
